(19) United States
(12) Patent Application Publication
(10) Pub. No.: US 2007/0001466 A1
(43) Pub. Date: Jan. 4, 2007

(54) Door furniture assembly

(76) Inventor: Charles Michael Vaiarella, Ferntree Gully (AU)

Correspondence Address: BRINKS HOFER GILSON & LIONE, P.O. BOX 10395, CHICAGO, IL, 60610, US

(21) Appl. No.: 11/453,394

(22) Filed: Jun. 15, 2006

(30) Foreign Application Priority Data
Jun. 17, 2005 (AU) 2005903190

(51) Int. Cl. E05B 3/00

(52) U.S. Cl. 292/336.3

(57) ABSTRACT

A door furniture assembly (2) comprising a door furniture body (4), a drive plate (12), a handle (6), a return mechanism (16), and a stop spring (22). The drive plate (12) is pivotally mounted within the door furniture body (4) and has a shoulder (14) thereon. The handle (6) is operatively associated with the drive plate (12), with the handle (6) and drive plate (12) being pivotable in an operating direction away from a rest position. The return mechanism (16) is operatively associated with the drive plate (12), with the return mechanism (16) being adapted to bias the drive plate (12) and handle (6) when pivoted in the operating direction, in an opposite return direction, towards the rest position. The stop spring (22) has a fixed end (26) secured within the door furniture body (4) and a free end (28) adapted to engage the shoulder (14) of the drive plate (12), when the drive plate (12) is in the rest position. Pivoting of the handle (6) in the return direction beyond the rest position is resisted by elastic deformation of the stop spring (22) by the shoulder (14) of the drive plate (12).

### TECHNICAL FIELD

The present invention relates to a stop mechanism and, in particular, to a flexible stop mechanism for use in door furniture The invention has been developed primarily for use in door furniture having a narrow escutcheon and will be described hereinafter with reference to this application. However, it will be appreciated that the invention is not limited to this particular field of use.

### DEFICIENCIES OF THE PRIOR ART

Door furniture designs are trending towards narrower escutcheons. However, reducing the size of the escutcheon also reduces the operating space within, which requires smaller internal mechanical components, such as the drive plate. These narrower designs also require proportionally smaller handles and hubs to reduce impact forces on the drive plate, such as when the handle is released and springs back to cause the drive plate to engage a fixed stop. However, the necessity for different sized handles and hubs for different furniture designs greatly reduces production efficiency and may limit product variety that can be supplied to the market.

If larger existing handles and hubs are installed on narrow escutcheon door furniture assemblies, then the size and weight of the handle and hub place excessive forces on the proportionately smaller drive plate and other internal components. In particular, when the handle is released and springs back, the impact of the smaller drive plate on the fixed stop is proportionately much larger and can cause cracking in the drive plate.

### OBJECT OF THE INVENTION

It is the object of the present invention to substantially overcome or ameliorate one or more of the disadvantages of the prior art or at least to provide a useful alternative.

### SUMMARY OF THE INVENTION

Accordingly, the present invention provides a door furniture assembly comprising:

a door furniture body;

a drive plate pivotally mounted within the door furniture body and having a shoulder thereon;

a handle operatively associated with the drive plate, the handle and drive plate being pivotable in an operating direction away from a rest position;

a return mechanism operatively associated with the drive plate, the return mechanism adapted to bias the drive plate and handle, when pivoted in the operating direction, in an opposite return direction, towards the rest position; and

a stop spring having a fixed end secured within the door furniture body and a free end adapted to engage the shoulder of the drive plate, when the drive plate is in the rest position,

wherein pivoting of the handle in the return direction beyond the rest position is resisted by elastic deformation of the stop spring by the shoulder of the drive plate.

In a preferred embodiment, the stop spring comprises a cantilevered leaf spring, most preferably in the form of a rectangular bar.

In a preferred embodiment, the door furniture body is provided with a catch adjacent the free end of the stop spring, the catch being adapted to engage the free end of the stop spring when the handle is pivoted a predetermined displacement beyond the rest position, in the return direction, to prevent plastic deformation of the stop spring.

Preferably, the door furniture assembly further comprises a hub pivotally mounted in the door furniture body, the drive plate and handle being mounted on the hub.

In a preferred embodiment, the door furniture assembly is interchangeable between opposite handing configurations. Preferably, the stop spring is removably securable in the door furniture body in either a first or second position, corresponding to a first and second handing arrangement of the door furniture assembly. Further preferably, the stop spring is removably securable by means of a screw.

### BRIEF DESCRIPTION OF THE DRAWINGS

A preferred embodiment of the invention will now be described, by way of example only, with reference to the accompanying drawings wherein:

FIG. 1 is a front view of the door furniture assembly in accordance with an embodiment of the present invention;

FIG. 2 is a left side view of the door furniture assembly of FIG. 1;

FIG. 3 is a top view of the door furniture assembly of FIG. 1;

FIG. 4 is a partially cut-away left side view of the door furniture assembly of FIG. 1;

FIG. 5 is a rear view of the door furniture assembly of FIG. 1, shown in a rest position;

FIG. 6 is a rear view of the door furniture assembly of FIG. 1, shown with the handle pivoted from the rest position in an operating direction;

FIG. 7 is a rear view of the door furniture assembly of FIG. 1, shown with the handle pivoted beyond the rest position in a return direction; and

FIG. 8 is a rear view of the door furniture assembly of FIG. 1, shown in the process of being arranged in an opposite handing configuration.

### DETAILED DESCRIPTION OF THE PREFERRED EMBODIMENTS

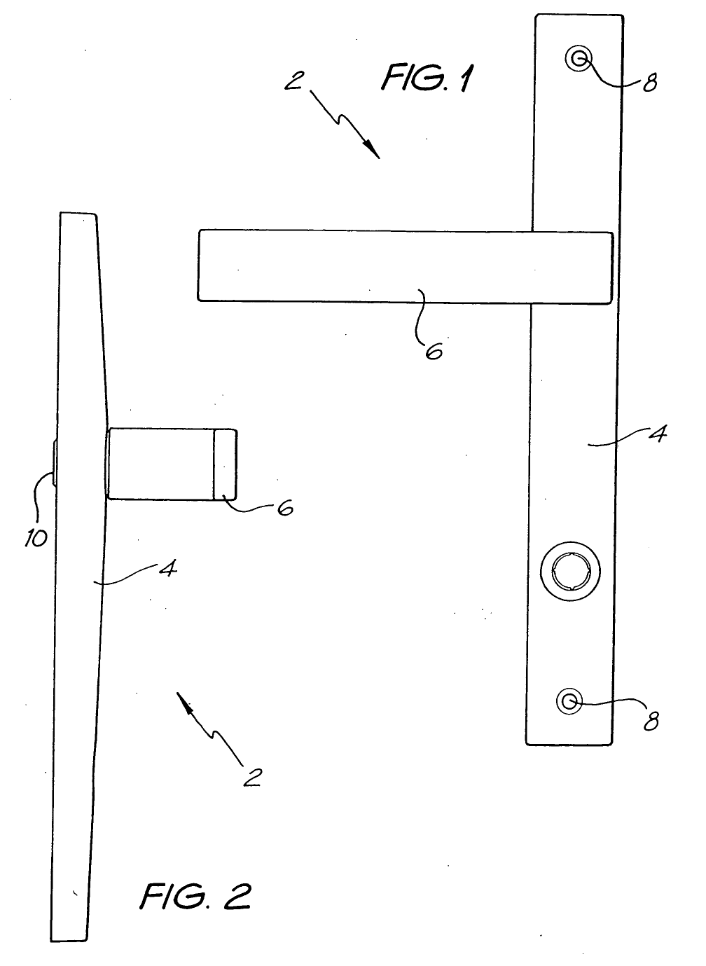

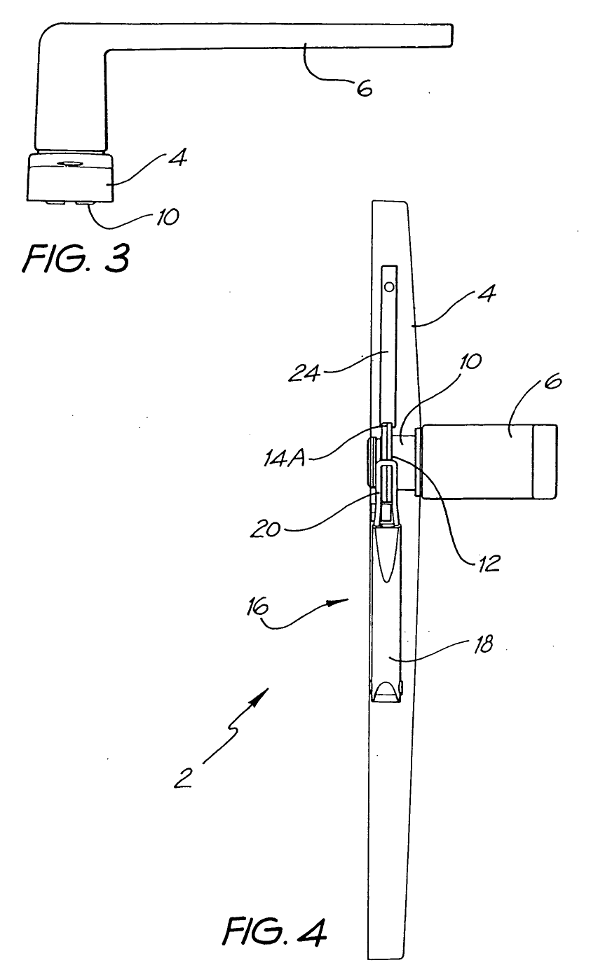

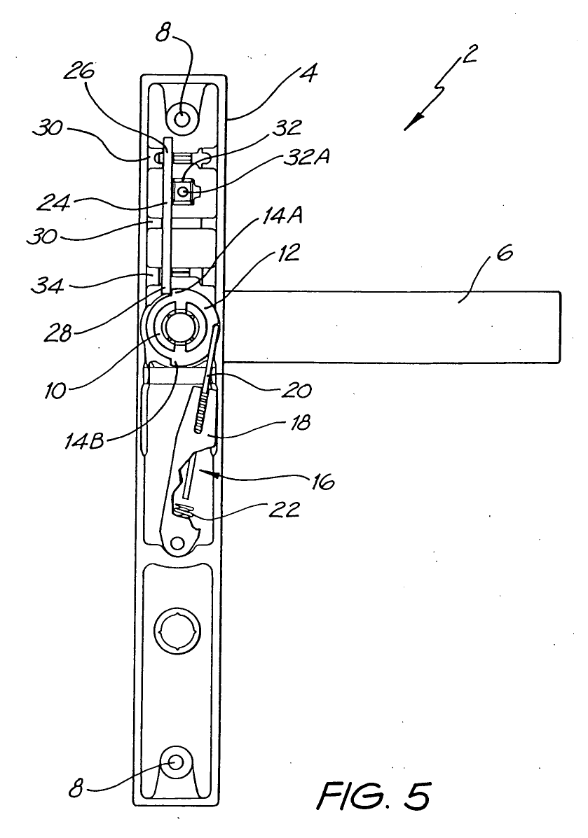

Referring to the drawings, FIG. 1 depicts a door furniture assembly 2 having a door furniture body, or escutcheon 4, and a lever handle 6 pivotally mounted on the escutcheon 4. The escutcheon 4 includes mounting holes 8 for mounting the door furniture assembly 2 to a door.

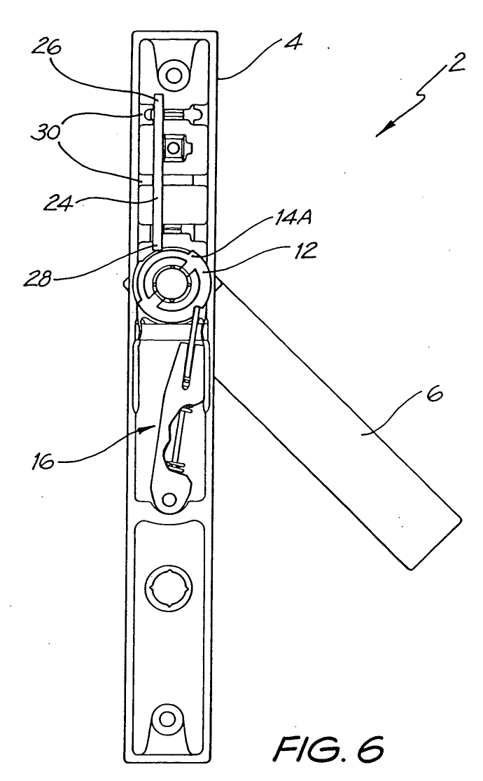

As best shown in FIG. 5, the handle 6 is mounted on the escutcheon 4 by way of a hub 10. A drive plate 12 is fixed to the inner end of the hub 3 and is provided with first and second shoulders 14A and 14B.

Mounted within the escutcheon 4, is a return mechanism 16. The return mechanism 16 comprises a pivotally mounted guide tube 18, a connecting rod 20 and a spring 22. The connecting rod 20 is secured at one end to the drive plate 12 and is adapted for sliding movement within the guide tube 18.

Also mounted within the escutcheon 4 is a stop spring 24 comprising a rectangular bar cantilever leaf spring The stop spring 24 preferably made from spring steel and is removably securable within the escutcheon 4 with a fixed end 26 distal to the drive plate 12 and a free end 28 proximal to the first shoulder 14A of the drive plate 12. The fixed end 26 is slotted into aligned slots formed between two spaced flanges 30 and catches 31 and 32. A screw fastening point 32A, provided between the two flanges 30, is adapted to receive a screw (not shown) which clamps the fixed end 26 of the stop spring 24 in place. A catch 34, formed by a further flange in the escutcheon 4, is provided adjacent the free end 28 of the stop spring 24 opposite the first shoulder 14A.

The door furniture assembly 2 is configured to remain in a rest position (shown in FIG. 5), unless an external force is applied to the handle 6. More particularly, in the rest position, the connecting rod 20 and spring 22 bias the handle 6 against pivoting in an is operating direction, and the free end 28 of the stop spring 24 engages the first shoulder 14A of the drive plate 12, biasing the handle 6 against pivoting in an opposite return direction.

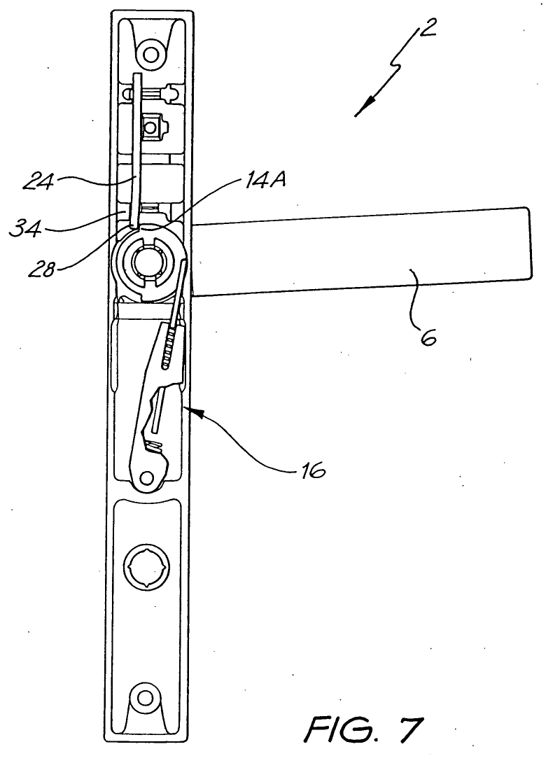

During operation (shown in FIG. 6), a user pivots the handle 6 downwardly, in the operating direction, which rotates the hub 10 and the drive plate 12 in the same direction. This compresses the return mechanism 16 by driving the connecting rod 20 into the guide tube 18 and compressing the spring 22. The return mechanism 16 also pivots slightly during this operation.

When the handle 6 is released, the return mechanism 16 expands as the spring 22 drives the connecting rod 20 out of the guide tube 18. This forces the drive plate 12 and hub 10 to pivot in the return direction, returning the handle 6 to the rest position.

When the handle 6 is pivoted in the operating direction during use and then suddenly released, the handle 6 is driven in the return direction and the momentum of the handle 6 carries the handle 6 beyond the rest position in the return direction. This over pivoting (shown in FIG. 7) is resisted by the stop spring 24, which elastically deforms and absorbs the momentum energy of the handle(s) 6. This minimises the impact between internal mechanisms of the door furniture assembly 2, allowing heavier handle and hub designs to be utilised within door furniture assemblies 2 having narrower escutcheons 4. This in turn allows manufacturers to produce different models of door furniture assemblies utilising the same handle and hub components, significantly increasing production efficiency and providing the market with a wide product range.

As best shown in FIG. 7, if the handle 6 is forced by a user to pivot in the return direction beyond the rest position, the catch 34 engages the free end 28 of the stop spring 24, preventing plastic deformation of the stop spring 24.

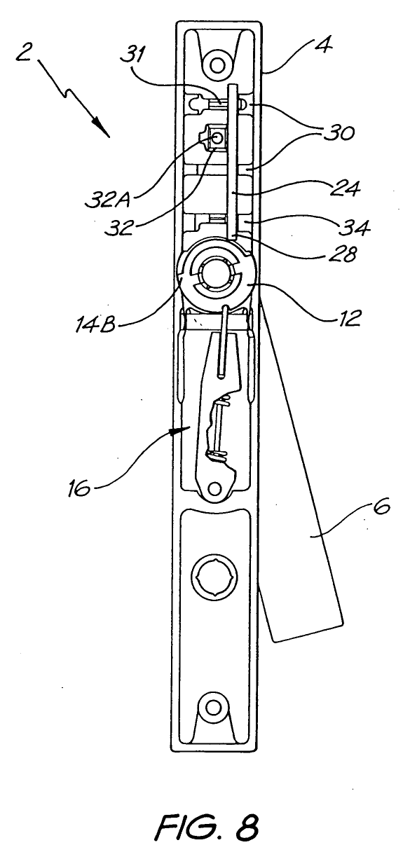

As best shown in FIG. 8, the door furniture assembly 2 can be rehanded by removing the stop spring 24, rotating the handle in the operating direction through 180°, and resecuring the stop spring 24 in a corresponding position on the opposite side of the escutcheon 4. In this opposite-handed configuration, the second shoulder 14B engages the stop spring 24 and the return mechanism 16 pivots to the opposite side of the is escutcheon 4. A corresponding catch 34 is provided on the opposite side of the escutcheon 4. In this way, the door furniture assembly 2 can be easily switched between left and right handed configurations and therefore, a single design of the door furniture assembly 2 can be utilised on both sides of a door.

Although the invention has been described with reference to a specific example, it will be appreciated by those skilled in the art that the invention may be embodied in other forms.

1. A door furniture assembly comprising:
a door furniture body;
a drive plate pivotally mounted within the door furniture body and having a shoulder thereon;
a handle operatively associated with the drive plate, the handle and drive plate being pivotable in an operating direction away from a rest position;
a return mechanism operatively associated with the drive plate, the return mechanism adapted to bias the drive plate and handle, when pivoted in the operating direction, in an opposite return direction, towards the rest position; and
a stop spring having a fixed end secured within the door furniture body and a free end adapted to engage the shoulder of the drive plate, when the drive plate is in the rest position,
wherein pivoting of the handle in the return direction beyond the rest position is resisted by elastic deformation of the stop spring by the shoulder of the drive plate.

2. The assembly as claimed in claim 1, wherein the stop spring comprises a cantilevered leaf spring.

3. The assembly as claimed in claim 2, wherein the leaf spring is in the form of a rectangular bar.

4. The assembly as claimed in claim 1, wherein the door furniture body is provided with a catch adjacent the free end of the stop spring, the catch being adapted to engage the free end of the stop spring when the handle is pivoted a predetermined displacement beyond the rest position, in the return direction, to prevent plastic deformation of the stop spring.

5. The assembly as claimed in claim 1, wherein the door furniture assembly further comprises a hub pivotally mounted in the door furniture body, the drive plate and handle being mounted on the hub.

6. The assembly as claimed in claim 1, wherein the door furniture assembly is interchangeable between opposite handing configurations.

7. The assembly as claimed in claim 1, wherein the stop spring is removably securable in the door furniture body in either a first or second position, corresponding to a first and second handing arrangement of the door furniture assembly.

8. The assembly as claimed in claim 1, wherein the stop spring is removably securable by means of a screw.
